(19) United States
(12) Patent Application Publication
(10) Pub. No.: US 2025/0132627 A1
(43) Pub. Date: Apr. 24, 2025

(54) MOTOR

(71) Applicant: NIDEC CORPORATION, Kyoto (JP)

(72) Inventors: Mitsuhiro TAKEMOTO, Kyoto (JP); Kenji FUKAMI, Kyoto (JP); Masahiro SHIRAISHI, Kyoto (JP)

(21) Appl. No.: 18/915,883

(22) Filed: Oct. 15, 2024

(30) Foreign Application Priority Data
Oct. 19, 2023 (JP) 2023-180555

(51) Int. Cl. H02K 3/50; H02K 1/30; H02K 7/08

(52) U.S. Cl. CPC H02K 3/50; H02K 1/30; H02K 7/083; H02K 2203/09

(57) ABSTRACT

A motor includes a rotor rotatable about a central axis extending in an axial direction, a stator including coil assemblies arranged in a circumferential direction, and a bus bar assembly including a bus bar to electrically connect end portions of the coil assemblies to each other. A rotor recessed portion recessed in the axial direction is defined in the rotor, and at least a portion of the bus bar is accommodated in the rotor recessed portion.

### CROSS-REFERENCE TO RELATED APPLICATIONS

The present application claims priority under 35 U.S.C. § 119 to Japanese Patent Application No. 2023-180555, filed on Oct. 19, 2023, the entire contents of which are incorporated herein by reference.

### 1. FIELD OF THE INVENTION

The present disclosure relates to motors.

### 2. BACKGROUND

Conventionally, it is known to use a bus bar to electrically connect lead wires of a coil wound around each tooth of a motor or to connect an external power supply to a lead wire of a coil. For example, conventionally, a bus bar is connected to a lead wire (winding end) of a coil. The bus bar is used as an external input terminal.

In a conventional motor, a lead wire of a coil is connected to a bus bar in a state of being drawn out to the upper side, that is, in a direction away from a rotor in a vertical direction. In this case, the motor increases in size in an axial direction accordingly.

### SUMMARY

An example embodiment of a motor of the present disclosure is a motor including a rotor rotatable about a central axis extending in an axial direction, a stator including a plurality of coil assemblies arranged in a circumferential direction, and a bus bar assembly including a bus bar to electrically connect end portions of the coil assemblies to each other. A rotor recessed portion recessed in the axial direction is defined in the rotor, and at least a portion of the bus bar is accommodated in the rotor recessed portion.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view schematically illustrating a motor according to an example embodiment of the present disclosure.

FIG. 2 is a plan view schematically illustrating a bus bar assembly according to an example embodiment of the present disclosure.

FIG. 3 is a side view schematically illustrating the bus bar assembly.

FIG. 4 is a diagram schematically illustrating a connection relationship between teeth, coil assemblies, and bus bars in the motor.

FIG. 5 is a cross-sectional view schematically illustrating the motor according to a variation, and is an enlarged view illustrating a portion around the bus bar assembly.

### DETAILED DESCRIPTION

Example embodiments of the present disclosure will be described below with reference to the drawings.

First, in the present description, a rotation axis of a motor 1 is referred to as a central axis CA, and a direction parallel to the central axis CA is referred to as “axial direction”. Further, one side in the axial direction from a lower bearing 7 to an upper bearing 6 is referred to as “upper side in the axial direction”, and another side in the axial direction from the upper bearing 6 to the lower bearing 7 is referred to as “lower side in the axial direction”. Further, of surfaces of each constituent element, a surface facing the upper side in the axial direction is referred to as “upper surface”, and a surface facing the lower side in the axial direction is referred to as “lower surface”. Further, in each constituent element, an end portion in the axially direction is referred to as “end portion in the axial direction”, and a position of an end portion in the axial direction is referred to as “end in the axial direction”. In particular, an end portion on the upper side in the axial direction is referred to as “upper end portion in the axial direction”, and a position of an end portion on the upper side in the axial direction is referred to as “upper end in the axial direction”. Furthermore, an end portion on the lower side in the axial direction is referred to as “lower end portion in the axial direction”, and a position of an end portion on the lower side in the axial direction is referred to as “lower end in the axial direction”.

Further, a direction in which a straight line orthogonal to the central axis CA extends is referred as “radial direction”. Further, one side in the radial direction toward the central axis CA is referred to as “inner side in the radial direction”, and another side in the radial direction away from the central axis CA is referred to as “outer side in the radial direction”. Regarding side surfaces of each constituent element, a side surface directed in the radial direction is referred to as “side surface in the radial direction”. Further, a side surface directed to the inner side in the radial direction is referred to as “inner side surface in the radial direction”, and a side surface directed to the outer side in the radial direction is referred to as “outer side surface in the radial direction”. Further, in each constituent element, an end portion in the radial direction is referred to as “end portion in the radial direction”, and a position of an end portion in the radial direction is referred to as “end in the radial direction”. In particular, an end portion on the inner side in the radial direction is referred to as “inner end portion in the radial direction”, and a position of an end portion on the inner side in the radial direction is referred to as “inner end in the radial direction”. Furthermore, an end portion on the outer side in the radial direction is referred to as “outer end portion in the radial direction”, and a position of an end portion on the outer side in the radial direction is referred to as “outer end in the radial direction”.

Further, a rotation direction about the central axis CA is referred to as “circumferential direction”. Further, in the circumferential direction, a counterclockwise direction with respect to the central axis CA when viewed from the upper side in the axial direction is referred to as “one circumferential direction Rd1”, and a clockwise direction with respect to the central axis CA when viewed from the upper side in the axial direction is referred to as “another circumferential direction Rd2”. Of side surfaces of each constituent element, a side surface directed in the circumferential direction is referred to as a “side surface in the circumferential direction”. Further, in each constituent element, an end portion in the circumferential direction is referred to as “end portion in the circumferential direction”, and a position of an end portion in the circumferential direction is referred to as “end in the circumferential direction”. In particular, an end portion in the one circumferential direction Rd1 is referred to as “one end portion in the circumferential direction”, and a position of an end portion in the one circumferential direction Rd1 is referred to as “one end in the circumferential direction”. Furthermore, an end portion in the another circumferential direction Rd2 is referred to as “another end portion in the circumferential direction”, and a position of an end portion in the another circumferential direction Rd2 is referred to as “another end in the circumferential direction”.

Note that names of directions, surfaces, end portions, and their positions described above do not indicate a positional relationship, a direction, or the like in a case where the motor is incorporated into an actual device. An example embodiment will be described with reference to the drawings hereinafter.

The motor 1 is a brushless motor that uses three-phase alternating current including a U phase, a V phase, and a W phase as drive current. The motor 1 according to the present example embodiment is what is called an inner rotor type motor in which a rotor rotates inside a substantially annular stator.

Note that the motor 1 described below can be applied to any device as long as the motor is applicable to the device, and can be applied to, for example, a ceiling fan. Further, the motor 1 can also be provided as a motor required to have small thickness, for example, at a joint portion of a robot arm.

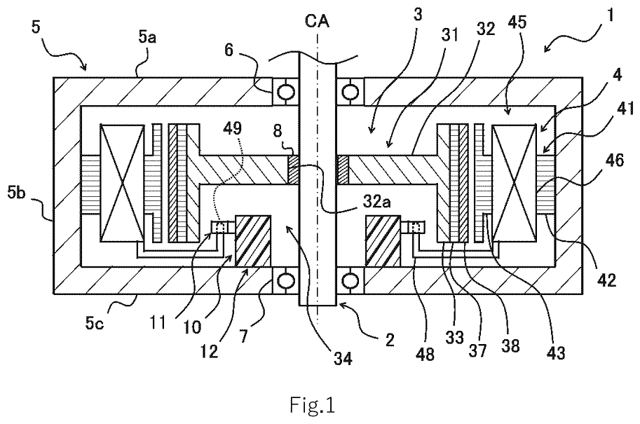

FIG. 1 is a cross-sectional view schematically illustrating the motor 1 according to the example embodiment. As illustrated in FIG. 1, the motor 1 includes a shaft 2, a rotor 3, a stator 4, a casing 5, and a bus bar assembly 10.

The casing 5 is a case-shaped component that accommodates the rotor 3 and the stator 4 in the inside. The casing 5 is formed in a slightly thin cylindrical shape in the axial direction with a space inside. The casing 5 includes an upper wall portion 5a having a substantially circular shape when viewed from the upper side in the axial direction, a peripheral wall portion 5b having a substantially cylindrical shape, and a lower wall portion 5c having a substantially circular shape when viewed from the lower side in the axial direction. Note that, in the example illustrated in FIG. 1, the casing 5 is schematically illustrated as an integrated member, but is not limited to this. For example, the upper wall portion 5a, the peripheral wall portion 5b, and the lower wall portion 5c may be formed as separate members and fixed to each other by screwing or the like.

A through hole is formed in a central portion as viewed from the upper side in the axial direction of the upper wall portion 5a of the casing 5, and the shaft 2 is inserted into and fixed to the through hole via the upper bearing 6. A through hole is formed in a central portion as viewed from the lower side in the axial direction of the lower wall portion 5c of the casing 5, and the shaft 2 is inserted into and fixed to the through hole via the lower bearing 7. By the above, the shaft 2 is rotatably held with respect to the casing 5.

The shaft 2 extends in the axial direction around the central axis CA, and is rotatable together with the rotor 3 about the central axis CA in the present example embodiment. That is, the shaft 2 is a rotation shaft of the motor 1. The shaft 2 is rotatably supported with respect to the casing 5 by the upper bearing 6 and the lower bearing 7. In the present example embodiment, the upper bearing 6 and the lower bearing 7 are ball bearings, but are not limited to this, and may be other types of bearings.

The rotor 3 is rotatable about the central axis CA extending in the axial direction. The motor 1 includes the rotor 3. As illustrated in FIG. 1, the rotor 3 includes a rotor bush 31, a rotor core 37, and a plurality of magnets 38.

The rotor bush 31 is a member formed by die casting, for example. The rotor bush 31 has a disc portion 32 and a cylindrical portion 33, which are integrally formed from a single material.

The disc portion 32 is a disc-shaped portion having thickness in the axial direction. A through hole 32a is formed at the center of the disc portion, and the shaft 2 is inserted and fixed to the through hole 32a via a tolerance ring 8 described in detail later.

The cylindrical portion 33 is a substantially cylindrical portion extending in the vertical direction. An inner peripheral surface of the cylindrical portion 33 is integrally fixed to an outer peripheral surface of the disc portion 32. Length in the axial direction of the cylindrical portion 33 is longer than length in the axial direction of the disc portion. The disc portion 32 is located slightly above a portion at the middle in the axial direction of the cylindrical portion 33.

As illustrated in FIG. 1, a rotor recessed portion 34 is provided in a portion below the disc portion 32 in the rotor bush 31. The rotor recessed portion 34 is a portion surrounded by a lower surface of the disc portion 32 and an inner peripheral surface of the cylindrical portion. By the above, an internal space of the rotor recessed portion 34 is formed in a substantially columnar shape. The rotor recessed portion 34 is recessed to the upper side in the axial direction. By the above, the rotor recessed portion 34 is opened toward the lower side in the axial direction. An upper portion of the bus bar assembly 10 described in detail later is accommodated in the rotor recessed portion 34.

The rotor core 37 is a cylindrical portion in contact with an outer peripheral surface of the cylindrical portion 33 of the rotor bush 31. The rotor core 37 of the present example embodiment is formed by laminating, in the axial direction, annular electromagnetic steel plates thin in the axial direction.

In the present example embodiment, sixteen of the magnets 38 are provided. A plurality of the magnets 38 are arranged and fixed on an outer peripheral surface in the circumferential direction of the rotor core 37 such different magnetic poles (that is, S poles and N poles) alternately face outward in the circumferential direction. For example, the magnet 38 is fixed to the rotor core 37 by an adhesive.

The rotor 3 is fixed to the shaft 2 by the tolerance ring 8. The tolerance ring 8 is a substantially cylindrical member made from metal and has spring property in the radial direction. In the present example embodiment, in a state where the shaft 2 is inserted into an inner peripheral surface of the tolerance ring 8, an outer peripheral surface of the tolerance ring 8 is inserted into an inner peripheral surface of a through hole of the rotor bush 31. By the above, since the tolerance ring 8 is compressed in the radial direction between the shaft 2 and the rotor 3, the shaft 2 and the rotor 3 are firmly fixed by repulsive force of the compression.

The stator 4 is formed in a substantially annular shape surrounding the rotor 3 from the outer side in the radial direction. The stator 4 includes a stator core 41, a plurality of coil assemblies 45, and the bus bar assembly 10.

The stator core 41 is a substantially annular magnetic body and is arranged so as to surround the rotor from the outer side in the radial direction. In the present example embodiment, the stator core 41 is configured by laminating, in the axial direction, electromagnetic steel plates having thickness in the axial direction. The stator core 41 includes an annular core back 42 and a plurality of (twelve in the present example embodiment) teeth 43 projecting toward the inner side in the radial direction from an inner peripheral surface of the core back 42. A plurality of the teeth 43 are arranged at equal intervals in the circumferential direction.

A plurality of the coil assemblies 45 include a coil main body portion 46 which is a portion wound around each of the teeth 43, a connecting wire portion 47 which connects the coil main body portions 46 to each other, and a lead wire portion 48 which extends in a direction away from the coil main body portion 46 and has a tip portion (coil end portion 49) electrically connected to the bus bar assembly 10. By the above, a plurality of the coil assemblies 45 are arranged in the circumferential direction.

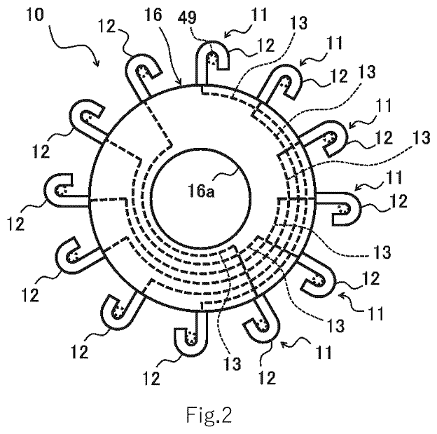

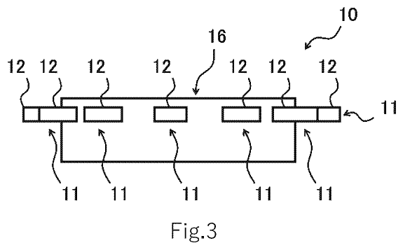

FIG. 2 is a plan view schematically illustrating the bus bar assembly 10. Further, FIG. 3 is a side view schematically illustrating the bus bar assembly 10.

The bus bar assembly 10 is a component for electrically connecting coil assemblies 22 arranged apart from each other in the circumferential direction. The bus bar assembly 10 includes a plurality of (six in the present example embodiment) bus bars 11 and a bus bar holding portion 16. In the bus bar assembly 10 according to the present example embodiment, positions of a plurality of the bus bars 11 formed by press working are fixed to each other by the bus bar holding portion 16 integrally molded from a resin material.

The bus bar 11 includes a pair of bus bar end portions 12 and a bus bar main body portion 13. Note that, in FIG. 3, the bus bar main body portion 13 embedded in the bus bar holding portion 16 is indicated by a broken line, and the broken line schematically illustrates a shape of the bus bar main body portion 13. The bus bar main body portions 13 may have any shape as long as they are not in contact with each other in a state of being incorporated in the bus bar assembly 10.

The bus bar end portion 12 is a portion that project to the outer side in the radial direction from the bus bar holding portion 16 and is exposed to the outside. The bus bar end portion 12 is formed in an alphabet J shape when viewed from above, and, in a state where the coil end portion 49 of the lead wire portion 48 is sandwiched in this portion, the bus bar end portion 12 is connected by soldering, welding, or the like.

In the bus bar assembly 10 according to the present example embodiment, twelve of the bus bar end portions 12 are arranged at equal intervals in the circumferential direction. That is, the bus bar end portions 12 are arranged at intervals of 30 degrees. A pair of the bus bar end portions 12 of one of the bus bars 11 are provided at positions of 180 degrees with respect to each other, and are connected by the bus bar main body portion 13.

The bus bar main body portion 13 is a portion embedded in the bus bar holding portion 16. The bus bar end portion 12 is provided to extend further to the outer side in the circumferential direction than the bus bar holding portion 16 from each of both end portions of each of the bus bar main body portions 13.

The bus bar holding portion 16 is a member made from a resin material. The bus bar holding portion 16 has a substantially columnar shape, and a holding portion through hole 16a penetrating a central portion of the bus bar holding portion 16 is formed. The bus bar main body portion 13 is embedded inside the bus bar holding portion 16. The bus bar assembly 10 is fixed to the lower wall portion 5c of the casing 5 such that the holding portion through hole 16a is coaxial with the shaft 2. Note that the bus bar assembly may be fixed to the stator core.

In the bus bar assembly 10, the bus bar main body portions 13 of the bus bars 11 are provided in the bus bar holding portion 16 in a manner not coming into contact with each other. Specifically, for example, by arranging the bus bar main body portions 13 at intervals in the axial direction and the radial direction, the bus bar main body portions 13 do not come into contact with each other. Note that, in FIG. 3, heights in the axial direction of the bus bar end portions 12 are the same, but the present disclosure is not limited to this, and heights in the axial direction of the bus bar end portions 12 may be different. By the above, contact between the bus bars 11 can be prevented.

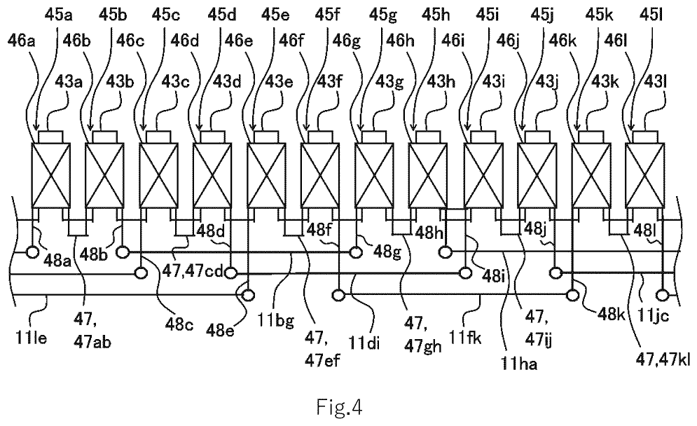

a FIG. 4 is a diagram schematically illustrating connection relationship between the teeth 43, the coil assemblies 45, and the bus bars 11 in the motor 1 according to the present example embodiment. In FIG. 4, for convenience of description, an arrangement direction of the teeth 43 is illustrated linearly. Further, in FIG. 4, alphabets (a, b, c, . . . ) are added to the end of some reference signs for convenience of description. Hereinafter, when each constituent element is distinguished and described, a reference sign with an alphabet added at the end is used, and when each constituent element is not distinguished and described, only a reference sign is used.

In the present example embodiment, a plurality of the coil assemblies 45 include a coil unit through which U-phase current flows, a coil unit through which V-phase current flows, and a coil unit through which W-phase current flows. In the example illustrated in FIG. 4, U-phase current flows through coil main body portions 46a, 46b, 46g, and 46h, V-phase current flows through coil main body portions 46c, 46d, 46i, and 46j, and W-phase current flows through coil main body portions 46e, 46f, 46k, and 46l. Note that the number of the coil main body portions 46 of each phase is not limited to that in the example of FIG. 4.

In the present example embodiment, the coil main body portions 46 of each phase adjacent to each other in the circumferential direction are connected by the connecting wire portion 47. Specifically, regarding a U phase, the coil main body portion 46a and the coil main body portion 46b are connected by a connecting wire portion 47ab, and the coil main body portion 46g and the coil main body portion 46h are connected by a connecting wire portion 47gh. Regarding a V phase, the coil main body portion 46c and the coil main body portion 46d are connected by a connecting wire portion 47cd, and the coil main body portion 46i and the coil main body portion 46j are connected by a connecting wire portion 47ij. Regarding a W phase, the coil main body portion 46e and the coil main body portion 46f are connected by a connecting wire portion 47ef, and the coil main body portion 46k and the coil main body portion 46l are connected by a connecting wire portion 47kl. The coil main body portion and the connecting wire portion may be formed from a series of coils, or end portions of the coil main body portions may be connected to each other by the connecting wire portion constituted by a different coil wire.

Further, in the present example embodiment, the lead wire portions of each phase arranged apart from each other in the circumferential direction are connected by the bus bars 11. Specifically, regarding a U phase, a lead wire portion 48b and a lead wire portion 48g are connected by a bus bar 11bg, and a lead wire portion 48h and a lead wire portion 48a are connected by a bus bar 11ha. Regarding a V phase, a lead wire portion 48d and a lead wire portion 48i are connected by a bus bar 11di, and a lead wire portion 48j and a lead wire portion 48c are connected by a bus bar 11jc. Regarding a W phase, a lead wire portion 48f and a lead wire portion 48k are connected by a bus bar 11fk, and a lead wire portion 48l and a lead wire portion 48e are connected by a bus bar 11le.

In the present example embodiment, as illustrated in FIG. 1, the bus bar assembly 10 is arranged in a manner that at least a part of the bus bar assembly 10 is accommodated inside the rotor recessed portion 34. Specifically, in the present example embodiment, an upper portion 41 the bus bar assembly 10 is accommodated inside the rotor recessed portion 34. By the above, for example, height in the axial direction of the motor 1 can be reduced as compared with a case where the bus bar assembly is arranged lower than a lower end surface of the rotor. That is, the motor 1 can be made thin.

Further, in the present example embodiment, the coil end portion 49, which is a tip portion of the lead wire portion 48, is accommodated inside the rotor recessed portion 34. This eliminates the need for extending the bus bar end portion to the outside of the rotor recessed portion, so that length of the bus bar can be made short.

Further, in the present example embodiment, the bus bar holding portion 16 is formed from a resin material integrally molded with the bus bar 11. By the above, an assembling process such as assembling the bus bar to the bus bar holding portion can be omitted, so that an assembling process of the motor can be simplified.

Further, in the present example embodiment, the bus bar assembly 10 is arranged between the upper bearing 6 and the lower bearing 7. By the above, the motor 1 can be made thin.

Further, in the present example embodiment, the tolerance ring 8 is used for coupling the shaft 2 and the rotor 3. By the above, the shaft 2 and the rotor 3 can be firmly fixed as compared with a case where the shaft 2 and the rotor 3 are simply fixed with an adhesive. Further, as illustrated in FIG. 1, the tolerance ring 8 has substantially the same length as length in the axial direction of the disc portion 32 of the rotor bush 31. Therefore, since a space of the rotor recessed portion 34 can be sufficiently secured, an arrangement space of the bus bar assembly 10 can be secured.

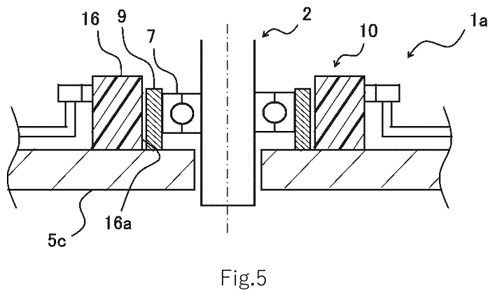

FIG. 5 is a cross-sectional view schematically illustrating a motor 1a according to a variation, and is an enlarged view illustrating a portion around the bus bar assembly 10.

In the above-described example embodiment, the example in which the lower bearing 7 is fixed to the lower wall portion 5c of the casing 5 is described, but the present disclosure is not limited to this. Specifically, the lower bearing 7 may be held by a bearing fixing member (in a case of the present variation, a bearing holding portion 9) fixed to the casing 5.

The bearing holding portion 9 is formed in a cylindrical shape by, for example, a metal member. The bearing holding portion 9 is fixed to the lower wall portion 5c of the casing 5 by, for example, screwing so that a central axis of the bearing holding portion 9 is coaxial with the shaft 2. An outer ring of the lower bearing 7 is fixed to an inner peripheral surface of the bearing holding portion 9. Note that the bearing holding portion 9 may be fixed with an adhesive, for example.

In the present variation, as illustrated in FIG. 5, the bearing holding portion 9 is accommodated inside the holding portion through hole 16a of the bus bar holding portion 16. That is, at least a part of the bearing holding portion 9 is arranged in the holding portion through hole 16a. In this way, since the bus bar assembly 10 and the bearing holding portion 9 can be arranged so as to overlap each other when viewed from the outer side in the radial direction, the motor can be made thin.

The example embodiment of the present disclosure is described above. Note that the scope of the present disclosure is not limited to the above-described example embodiment. The present disclosure is implemented by adding various modifications to the above-described example embodiment within a range not departing from the spirit of the disclosure. Further, the matters described in the above-described example embodiment can be optionally combined together as appropriate within a range where no inconsistency occurs.

In the present example embodiment, three-phase alternating current is used as drive current in the motor. However, the present disclosure is not limited to this example, and drive current of the motor may be single-phase alternating current.

In the present example embodiment, the motor in which a circuit board for controlling drive of the motor is not provided in the casing is described as an example, but the present disclosure can also be applied to a motor in which a circuit board is provided in a casing.

In the present example embodiment, an example in which all of two of the coil main body portions 46 separated in the circumferential direction (in other words, two of the coil main body portions 46 sandwiching one or more coil assemblies in the circumferential direction) are electrically connected by the bus bar 11 is described, but the present disclosure is not limited to this. Specifically, as long as at least a part of the bus bars is accommodated in the rotor recessed portion 34, the number of such bus bars may be any number.

In the present example embodiment, the bus bar holding portion integrally molded with the bus bar is described as an example of the bus bar holding portion, but the present disclosure is not limited to this. For example, a bus bar holding portion in which a groove portion capable of accommodating a bus bar is formed may be formed by resin molding or the like, and the bus bar may be fitted into the bus bar holding portion to form a bus bar assembly.

Hereinafter, the example embodiment described above will be described comprehensively below.

A motor in a configuration (first configuration) includes: a rotor rotatable about a central axis extending in an axial direction; a stator including a plurality of coil assemblies arranged in a circumferential direction; and a bus bar that electrically connects end portions of the coil assemblies to each other, a rotor recessed portion recessed in the axial direction is formed in the rotor, and at least a part of the bus bar is accommodated in the rotor recessed portion.

Note that the motor of the first configuration may have a configuration (second configuration), in which the end portion of each of the coil assemblies is accommodated in the rotor recessed portion.

Note that the motor of the first or second configuration may have a configuration (third configuration) in which the motor further includes: a plurality of the bus bars; and a bus bar holding portion that holds the plurality of bus bars, and the bus bar holding portion is formed from a resin material integrally molded with the plurality of bus bars.

Further, the motor of the third configuration may have a configuration (fourth configuration) in which the motor further includes: a shaft that is inserted into and fixed to the central axis of the rotor and rotates with rotation of the rotor; and a pair of bearings rotatably supporting the shaft, a holding portion through hole penetrating the bus bar holding portion in the axial direction is formed in the bus bar holding portion, and at least a part of a bearing holding portion that holds one of the pair of bearings is arranged in the holding portion through hole.

The motor having any of the first to fourth configurations may have a configuration (fifth configuration), in which the bus bar assembly is arranged between the pair of bearings in the axial direction.

Further, the motor of the fourth or fifth configuration may have a configuration (sixth configuration) in which the motor further includes a tolerance ring that is arranged between the rotor and the shaft and couples the rotor and the shaft.

The present disclosure is useful for a motor having a bus bar.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor rotatable about a central axis extending in an axial direction;
a stator including coil assemblies arranged in a circumferential direction; and
a bus bar assembly including a bus bar to electrically connect end portions of the coil assemblies to each other;
wherein
a rotor recessed portion recessed in the axial direction is defined in the rotor; and
at least a portion of the bus bar is accommodated in the rotor recessed portion.

2. The motor according to claim 1, wherein the end portion of each of the coil assemblies is accommodated in the rotor recessed portion.

3. The motor according to claim 2, wherein
the bus bar assembly includes:
a plurality of the bus bars; and
a bus bar holding portion to hold the plurality of bus bars; and
the bus bar holding portion is made from a resin material integrally molded with the plurality of bus bars.

4. The motor according to claim 3, further comprising:
a shaft that is inserted into and fixed to the central axis of the rotor and is rotatable with rotation of the rotor; and
a pair of bearings rotatably supporting the shaft;
wherein
a holding portion through hole penetrating the bus bar holding portion in the axial direction is defined in the bus bar holding portion; and
at least a portion of a bearing holding portion to hold one of the pair of bearings is arranged in the holding portion through hole.

5. The motor according to claim 4, wherein the bus bar assembly is located between the pair of bearings in the axial direction.

6. The motor according to claim 4, further comprising a tolerance ring that is located between the rotor and the shaft and couples the rotor and the shaft.
